(19) United States
(12) Patent Application Publication
(10) Pub. No.: US 2025/0186913 A1
(43) Pub. Date: Jun. 12, 2025

(54) FILTER FOR AN EQUIPMENT FOR WASHING LAUNDRY OR TEXTILE ITEMS

(71) Applicant: Electrolux Appliances Aktiebolag, Stockholm (SE)

(72) Inventors: Carlo Antonio LEONE, Pordenone (IT); Stefano CASAGRANDE, Cordenons (IT); Giacomo BRUNO, Cordenons (IT); Marco MARIUZZO, Cordenons (IT)

(73) Assignee: Electrolux Appliances Aktiebolag, Stockholm (SE)

(21) Appl. No.: 18/967,175

(22) Filed: Dec. 3, 2024

(30) Foreign Application Priority Data
Dec. 11, 2023 (IT) 102023000026361

(51) Int. Cl. B01D 29/64; B01D 29/35; B01D 29/60; D06F 33/43; D06F 34/20; D06F 39/08; D06F 39/10

(52) U.S. Cl. CPC B01D 29/6476; B01D 29/35; B01D 29/60; D06F 33/43; D06F 34/20; D06F 39/083; D06F 39/10; B01D 2201/325

(57) ABSTRACT

A filter assembly for filtering a fluid used in an appliance for washing laundry or textile articles including a filtering element enclosing an inlet chamber suitable for receiving the fluid; a housing for the filtering element; an outlet chamber defined by a volume between the filtering element and the housing; an inlet through which the fluid is supplied to the inlet chamber; an outlet in fluid communication with the outlet chamber; a cleaning system located within the inlet chamber adapted to remove filtered contaminants from the filtering surface and including a scraper device adapted to be rotated about a rotation axis to remove filtered contaminants from the filtering surface, and to move the removed filtered contaminants away from the inlet chamber; a collection region for collecting the removed filtered contaminants.

### BACKGROUND OF THE PRESENT INVENTION

### Field of the Present Invention

The present invention generally relates to the field of laundry or textile washing appliance, and in particular to a filter assembly for filtering contaminants from a fluid used by a laundry or textile washing appliance. The invention also relates to a laundry or textile washing appliance provided with the filter assembly and to a method for operating the filter assembly.

### Overview of Related Art

Different types of appliances for washing laundry or textile items, both for domestic and professional applications, use one or more fluids during their operation.

Referring, for example, to household appliances for washing textile products (e.g., clothes), such as washing machines or washer/dryers for washing and drying laundry, such fluids may include water and/or water mixed with chemical treatment agents for textile products, such as detergents, fabric softeners, dyes, stain removers, and so on.

It is known to equip such appliances with special devices or filter units designed to filter the fluid from contaminants including undesired materials present in the fluid. Examples of contaminants include foreign bodies, such as coins, gravel, metal elements, buttons, hair, which were in the textile products at the start of the treatment, and/or elements, such as filaments, fluff, etc. which make up the textile products themselves and which detach from them during the treatment operations performed by the appliance. Contaminants can compromise the correct performance of the treatment operations, for example if the fluid including contaminants were recirculated in the appliance, and/or can have a significant environmental impact, for example if the fluid including contaminants were discharged from the appliance into a drainage system. Among the contaminants released by textile products, particularly those of a synthetic nature, having a very significant environmental impact, the so-called “microplastics” can be identified, i.e., particles of plastic material with dimensions ranging from a few millimetres to a few microns. As known, microplastics pollution is considered a threat to the ecosystem and human and animal health.

Known filter assemblies comprise a cylindrical filtering element with filtering walls and a filter housing enclosing the filtering element. Fluid coming from an inlet port of the filter assembly is forced to enter a volume enclosed by the filtering element and to reach a volume of the filter assembly between the filter housing and the filtering element by passing through the filtering walls of the filtering element. The filtering walls of the filtering element are configured to retain contaminants larger than a predefined size. In this way, the filtered contaminants remain within the volume enclosed by the filtering element, and the fluid reaching the volume between the filter housing and the filtering element is free of the filtered contaminants. The filtered fluid is then discharged out of the filter assembly through an outlet port.

With the use of the filter assembly, the filtering walls of the filtering element become dirty, clogged with the contaminants retained, and therefore the effectiveness of the filter assembly can be compromised. In the event of excessive clogging that no longer allows the fluid to pass through the filtering walls, the filter assembly can no longer function and can even be damaged due to the overpressures that are generated in the filter housing and in the filter itself due to the clogging of the filtering walls.

For this reason, it is known to perform cleaning operations aimed at removing contaminants from the filtering walls of the filtering element.

EP4115966A1 shows a filtering system for a household appliance comprising a filter with a filtering surface for filtering particles from a fluid, a cleaning element, and a cleaning element actuating device for moving the cleaning device with a translational and rotational motion relative to the filtering surface.

### SUMMARY OF THE PRESENT INVENTION

The Applicant observed that the solutions known in art are not efficient, presenting drawbacks.

In particular, in the filtering system shown in EP4115966A1, the particles removed from the filtering surfaces by the action of the cleaning element progressively accumulate inside the filter. If the user does not frequently open the filter system to inspect the amount of particles accumulated inside the filter to decide whether to empty the filter or not, the amount of particles accumulated inside the filter could compromise the operation of the cleaning element and/or the overall operation of the filtering system. In a filtering system such as that shown in EP4115966A1, the user has no way of defining when it is necessary to empty the filter from the amount of particles accumulated inside it, without incurring a malfunction of the filter or intervening well in advance of when actually necessary.

In view of the above, the Applicant has devised a filter assembly that is not affected by the aforementioned drawbacks.

One or more aspects of the present invention are set forth in the independent claims, with advantageous features of the same invention being indicated in the dependent claims, the wording of which is incorporated herein by reference.

One aspect of the present invention relates to a filter assembly for filtering a fluid used in an appliance for washing laundry or textile articles.

The filter assembly comprises a filtering element enclosing an inlet chamber adapted to receive said fluid.

The filter assembly comprises a housing adapted to house the filtering element.

The filter assembly comprises an outlet chamber defined by a volume comprised between the filtering element and the housing for receiving the filtered fluid resulting from the passage of the fluid from the inlet chamber through a filtering surface of the filtering element.

The filter assembly comprises an inlet through which the fluid is supplied to the inlet chamber.

The filter assembly comprises an outlet fluidly connected to said outlet chamber, through which the filtered fluid exits the outlet chamber.

The filter assembly comprises a cleaning system located inside the inlet chamber apt to remove filtered contaminants from the filtering surface.

The cleaning system comprises a scraper device adapted to be rotated about a rotation axis for removing filtered contaminants from said filtering surface through the mechanical interaction of the scraper device with the filtering surface during rotation of the scraper device, and for moving the removed filtered contaminants away from the inlet chamber.

The filter assembly comprises a collection region for collecting the removed filtered contaminants moved away from the inlet chamber.

The scraper device is configured to be movable with respect to the filtering element along the rotation axis by means of a pushing action of the collected filtered contaminants when an amount of filtered contaminants is collected in the collection region.

The filter assembly further comprises a position sensing system configured to sense the position of the scraper device along the rotation axis and to provide a signal indicative of the sensed position.

According to an exemplary embodiment, the scraper device comprises an endless screw comprising a blade surrounding a central shaft. Advantageously, an endless screw allows for effective cleaning of the scraped surface and allows for a pushing force to be imparted on the material removed from the scraped surface in a preferred direction.

In an exemplary embodiment, said blade is configured to mechanically interact with the filtering surface.

In a further embodiment, instead of or in addition to a blade, the scraper device may be provided with brush elements that interact mechanically with the filtering surface.

According to an exemplary embodiment, said rotation axis is substantially parallel to said filtering surface. Thanks to this configuration, the movement of the scraper device allows for an effective cleaning of the filtering surface by removing and displacing the filtered contaminants.

In an exemplary embodiment, the filter assembly comprises guide elements coupled to the inlet chamber that extend along the rotation axis.

In an exemplary embodiment, the guide elements are configured to slidingly engage with the scraper device to allow movement of the scraper device with respect to the inlet chamber along the rotation axis. The guide elements allow maintaining the scraper device in the correct position relative to the filtering surface during its movement along the rotation axis.

According to an exemplary embodiment, the pushing action of the collected filtered contaminants acting on the scraper device can be contrasted by a biasing element associated with the scraper device. The biasing element allows the scraper device to be moved back to the position taken in the clean filter assembly condition when the collected filtered contaminants are removed from the filter assembly itself.

According to an exemplary embodiment, the biasing element is an elastically deformable element, such as a spring.

According to an exemplary embodiment, the scraper device is configured to compact the removed filtered contaminants in the collection region by pressing the removed filtered contaminants in the collection region along the rotation axis in a first direction during rotation of the scraper device. The removal of the filtered contaminants and their movement in a preferential direction helps to keep the filtering surface clean for a long time, avoiding the redeposition of the removed filtered contaminants on the filtering surface itself.

According to an exemplary embodiment, the scraper device may be movable by means of the pushing action of the collected filtered contaminants along the rotation axis of the scraper device in a second direction opposite to the first direction. The pushing action exerted on the scraper device by the filtered contaminants collected in the collection region allows the displacement of the scraper device along the rotation axis to be related to the amount of contaminants present in the collection region.

According to an exemplary embodiment, a scraper device is provided which, when mounted in the filter assembly and in the condition in which the collection region is empty, that is, it does not contain contaminants, extends inside the collection region for a length, measured along the rotation axis, between 1 mm and 10 mm, preferably between 1 mm and 5 mm.

According to an exemplary embodiment, a scraper device is provided which, when mounted in the filter assembly and in the condition in which the collection region is empty, that is it does not contain contaminants, occupies a volume within the collection region between 5% and 25% of the volume of the collection region, preferably between 5% and 15% of the volume of the collection region, more preferably between 5% and 10% of the volume of the collection region.

The different size ranges or percentage ranges defined above for the linear penetration of the scraper device into the collection region, or for the percentage of volume occupancy of the collection region by the scraper device, can be applied based on the desired sensitivity of the sensing of the displacement of the scraper device along its rotation axis caused by the accumulation of contaminants in the collection region.

According to an exemplary embodiment, the position sensing system of the scraper device may comprise a magnetic position sensor. However, other types of position sensor systems may be used, such as capacitive, inductive, optical, piezoelectric position sensor systems, devices equipped with encoders or potentiometers.

According to an exemplary embodiment, the filter assembly may comprise a flooding chamber fluidly connected to the outlet chamber and fluidly connectable to the inlet chamber in a selective manner by means of a fluid communication device operable for enabling a fluid communication between the inlet chamber and the flooding chamber in presence of a clogging of the inlet chamber and/or the filtering element, thereby allowing unfiltered fluid to flow towards the outlet of the filter assembly. In the event that the fluid to be filtered cannot pass through the filtering element, for example, because the latter is completely clogged, the fluid accessing the filter assembly may be evacuated without filtration, thereby avoiding possible damage to the components of the filter assembly.

According to an exemplary embodiment, the inlet chamber enclosed by the filtering element may comprise a first inlet chamber portion fluidly connected to said inlet, and a second inlet chamber portion selectively fluidly separated from the first inlet chamber portion. The partition of the inlet chamber into two or more portions allows for the selective use of different areas of the filtering surface of the filtering element for the filtration of the fluid to be filtered, thus managing the overall degree of clogging of the entire filtering element.

According to an exemplary embodiment, the scraper device may be located in a first portion of the inlet chamber. In this way, only a portion of the filtering surface of the filtering element will be continuously cleaned by the scraper device, while a second portion of the inlet chamber different from the first one may be used for occasional filtering of the fluid to be filtered.

According to an exemplary embodiment, the filter assembly may comprise a fluid connection device comprising a displaceable body for selectively enabling and disabling a fluid connection between the first and second inlet chamber portions based on a working condition of the first inlet chamber portion. In this way, fluid communication between the first and second inlet chamber portions may be established only when the first inlet chamber portion and/or the filtering surface enclosing it exhibits an abnormal operating situation.

According to an exemplary embodiment, an enablement of a fluid connection between the first and second inlet chamber portions may occur based on a working condition indicating a clogging of a first inlet chamber portion, thereby allowing fluid to flow from the inlet of the filter assembly to a second inlet chamber portion through the first inlet chamber portion. In the event that the filtration efficiency of the filtering surface enclosing the first inlet chamber portion fails, such efficiency may be at least temporarily fully restored by assigning to the filtering surface enclosing the second inlet chamber portion the task of carrying out the filtration process.

According to an exemplary embodiment, a disablement of a fluid connection between the first and second inlet chamber portions may occur when the working condition is indicative of a non-clogging of the first inlet chamber portion, to place the first and second inlet chamber portions in fluid separation. Should the first inlet chamber portion return to operating efficiency, access of the fluid to be filtered to the second inlet chamber portion would be precluded, thus advantageously maintaining the operating efficiency of the second inlet chamber portion as well.

According to an exemplary embodiment, the second inlet chamber portion can receive the fluid to be filtered from the inlet of the filter assembly only when the fluid connection between the first and second inlet chamber portions is enabled. This technical solution allows to precisely control which portion of the inlet chamber should be affected by the inlet of the fluid to be filtered.

According to an exemplary embodiment, said filtering surface of the filtering element comprises a mesh having a size configured to retain particles having a minimum size of between 0.1 μm and 5 mm, preferably a minimum size of between 10 μm and 100 μm, more preferably a minimum size of between 10 μm and 75 μm. Thanks to these dimensions of the filtering mesh, the portions of fabric, in particular synthetic fabric, that might happen to be released into the treatment fluid during a washing process would be retained in the filtering element and not discharged downstream of it with the flow of fluid exiting the appliance for washing laundry or textile articles.

According to an exemplary embodiment, the filter assembly may comprise an electric motor configured to rotate the scraper device around the rotation axis. The presence of an electric motor allows the scraper device to be actuated based on an operating parameter of the filter assembly and/or of a laundry or textile washing appliance to which the filter assembly is hydraulically connected.

According to an exemplary embodiment, the collection region may be located at one end of the inlet chamber enclosed by the filtering element. In this position, collection of filtered contaminants removed from the filtering surface and displaced by the scraper device is facilitated, avoiding dispersing the contaminants along tortuous movement paths. According to an exemplary embodiment, the collection region may be defined by a collection chamber element that is configured to be selectively associated/dissociated from the inlet chamber. Due to the removability of the collection chamber element, periodic emptying of the filtered contaminants removed from the filter assembly for their proper disposal is easily possible.

According to an exemplary embodiment, the filter assembly may comprise an output system configured to provide, based on a signal indicative of the sensed position of the scraper device, an indication comprising one or more of the following:
an indication of the quantity of contaminants accumulated in the collection region;
an indication regarding a filling condition of the collection region;
an indication of the need to empty the collection region.

According to an exemplary embodiment, an indication regarding a filling condition of the collection region may be configured in terms of predefined levels (e.g., “empty”, “half full”, “full”), each corresponding to a respective predefined range of values of said signal. A progressive indication of the filling condition of the collection region allows a user to be informed relatively in advance of the occurrence of a complete filling of the collection region and to decide whether or not to perform a manual emptying operation of contaminants from the filter assembly based on the subsequent use of the filtering function of the filter assembly that the user intends to make.

According to an exemplary embodiment, an indication of the need to empty the collection region can be generated when a signal indicative of the sensed position of the scraper device has reached a predefined threshold value. Defining thresholds for the signal indicative of the sensed position of the scraper device is useful and advantageous for discriminating signal values relating to temporary displacement conditions of the scraper device during its operation. Such temporary conditions generate fluctuations in the signal that are not representative of the need to empty the collection region and should therefore be discriminated as ‘noise’ of the signal.

According to an exemplary embodiment, an indication provided by the output system may be provided in the form of visual indications, for example by lighting up appropriate lights or displaying messages on display elements such as a screen.

According to an exemplary embodiment, an indication provided by the output system may also, or instead, be provided in the form of audible indications, for example by generating audio alerts. Visual or audible indications help the user to immediately recognize the information content of the provided indication.

According to an exemplary embodiment, the indication may also, or instead, be provided in the form of a signal, digital or analog, to be sent to a device external to the filter assembly, such as a smartphone equipped with an appropriate application capable of interacting with the output system, or to be sent to a control unit of the laundry or textile washing appliance to which the filter assembly is hydraulically connected. In this way, the indication provided in the form of a signal may be processed and/or used by an algorithm to define a usage recommendation addressed to the user and/or an operating condition of the laundry or textile washing appliance.

According to an exemplary embodiment, the output system may be provided externally to the filter assembly. For example, the output system may be provided in the laundry or textile washing appliance to which the filter assembly is connected, or the functions of the output system may be performed by the control unit of the laundry or textile washing appliance that controls its various operating functions. In this way, the construction of the filter assembly is simplified.

According to an exemplary embodiment, under operating conditions, the rotation axis of the scraper device may be parallel to a direction of a prevailing extension dimension of the inlet chamber.

According to an exemplary embodiment, said direction of a prevailing extension dimension of the inlet chamber may be a vertical direction or a horizontal direction relative to a ground plane. Another aspect of the present invention relates to an appliance for washing laundry or textile articles comprising:
a control unit configured to control a laundry or textile articles treating operation by the appliance and a drain pipe to drain fluid from a laundry or textile articles treating chamber into a recirculation conduit to supply said fluid back to the laundry or textile articles treating chamber and/or a drain outside the appliance;
a filter assembly, wherein the inlet of the filter assembly is fluidly connected to the drain pipe and the outlet of the filter assembly is connected to the recirculation conduit and/or the drain.

For example, the appliance for washing laundry or textile articles may be a washing machine configured for washing only, or a washer/dryer configured for washing and drying laundry or textile articles.

Another aspect of the present invention relates to a method of operating a filter assembly having a combination of the features illustrated above.

The method comprises:
operating the scraper device of the cleaning system to rotate it around a rotation axis;
removing the filtered contaminants from the filtering surface through mechanical interaction of the scraper device with the filtering surface during rotation of the scraper device;
moving the removed filtered contaminants away from the inlet chamber by means of rotation of the scraper device;
collecting the removed filtered contaminants moved away from the inlet chamber in the collection region;
providing a signal indicative of the position of the scraper device which moves relative to the filtering element along the rotational axis by means of a pushing action of the collected filtered contaminants when an amount of filtered contaminants is collected in the collection region.

According to an exemplary embodiment, the method may further comprise:
establishing a fluid connection between the inlet of the filter assembly and a drain pipe of the laundry or textile articles washing appliance, wherein the drain pipe is provided to drain fluid from the laundry or textile articles treating chamber;
establishing a fluid connection between the filter assembly outlet and a recirculation conduit to supply fluid back to the laundry or textile articles treating chamber and/or connecting the filter assembly outlet to a drain outside to the equipment;
communicatively coupling the control unit of the laundry or textile washing appliance with the position sensing system of the filter assembly.

### BRIEF DESCRIPTION OF THE DRAWINGS

FIG. 1A is an exploded view of a filter assembly according to a first exemplary embodiment;

FIGS. 1B and 1C are sectional views of the filter assembly of FIG. 1A in a first and second operating conditions, respectively;

FIGS. 2A and 2B are sectional views of a filter assembly in accordance with a second exemplary embodiment of the present invention;

FIG. 3 is a sectional view of a filter assembly in accordance with a third exemplary embodiment of the present invention;

FIG. 4 schematically illustrates an example of how a filter assembly can be connected to an appliance for washing laundry or textile articles.

### DETAILED DESCRIPTION OF EXEMPLARY AND NON-LIMITING EMBODIMENTS OF THE PRESENT INVENTION

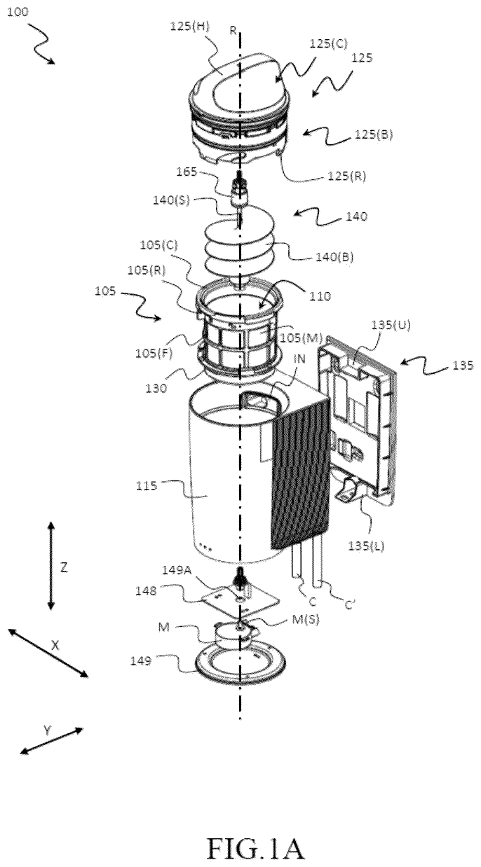

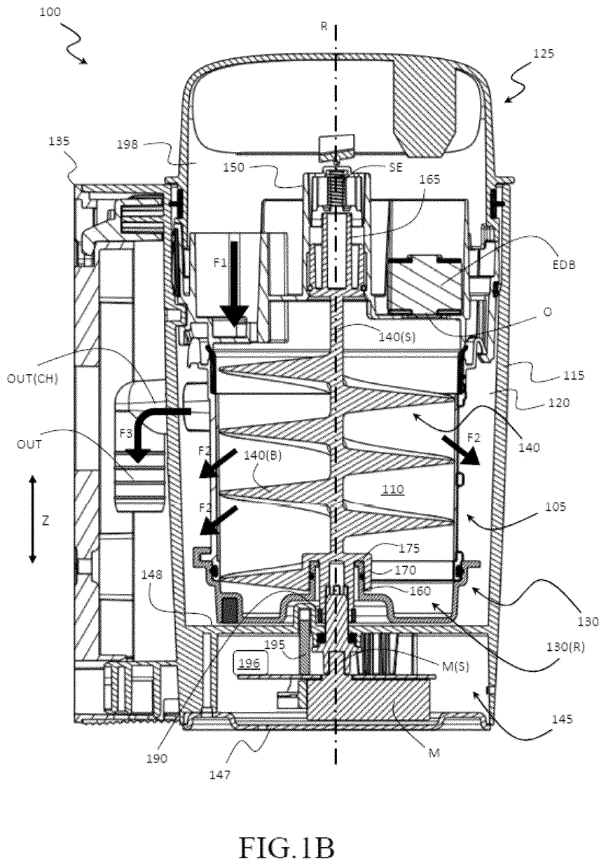

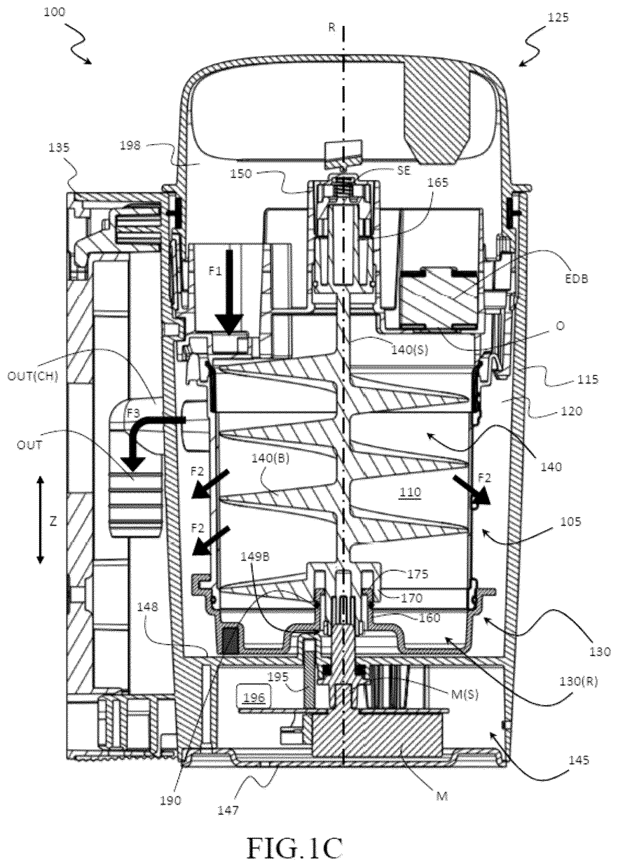

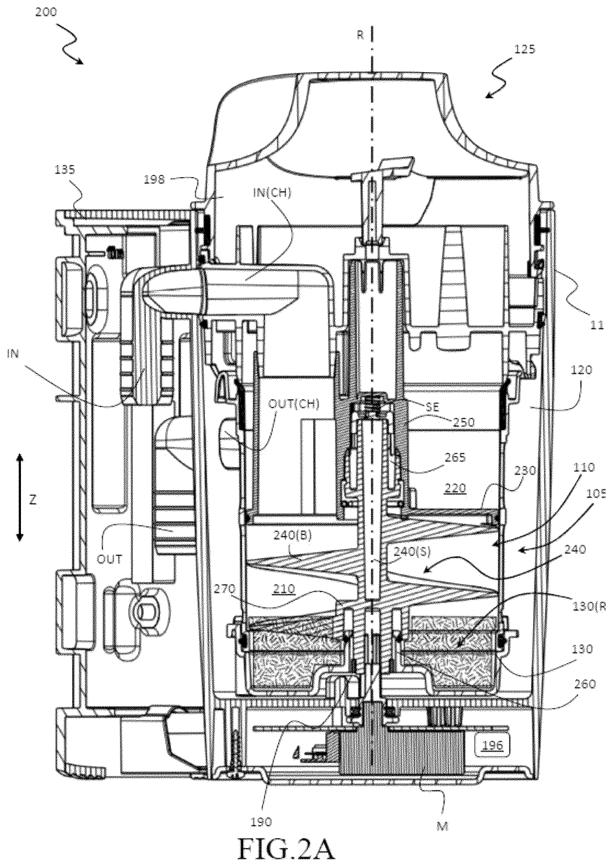

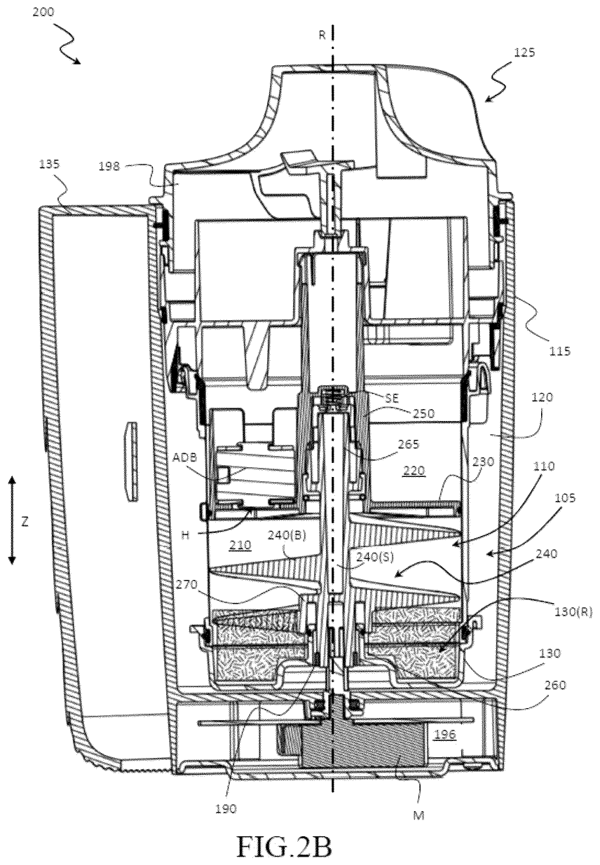

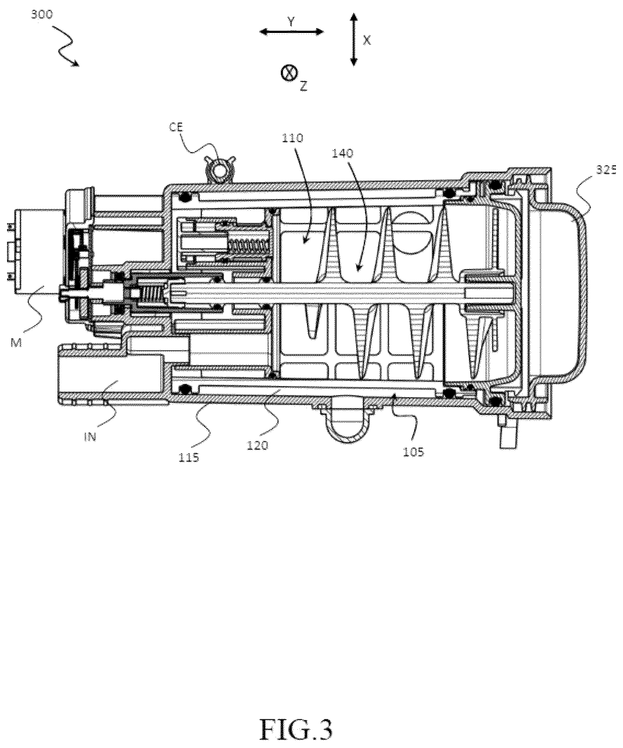

Referring to the drawings, FIGS. 1A-3 illustrate filter assemblies 100 (FIGS. 1A-1C), 200 (FIGS. 2A, 2B), 300 (FIG. 3) according to exemplary embodiments of the present invention.

The filter assemblies in accordance with exemplary embodiments of the present invention are particularly advantageous when used to filter a fluid to be discharged/recirculated from/into a laundry or textile articles washing appliance (e.g. for domestic or professional use) such as a washing machine or a washer/dryer. However, it is emphasized that the filter assemblies in accordance with exemplary embodiments of the present invention are not exclusively limited to such use. Instead, the filter assemblies in accordance with exemplary embodiments of the present invention may be conveniently used to filter fluids used by various types of appliances.

The filter assemblies according to exemplary embodiments of the present invention are particularly advantageous when used to filter a fluid from microplastics contained therein, so as to prevent such microplastics from being recirculated in the appliance, and/or to reduce their environmental impact when the fluid is discharged from the appliance. However, it is emphasized that the filter assemblies according to exemplary embodiments of the present invention are not limited exclusively to filtering fluids from microplastics, but can be used to filter different types of contaminants, such as lint (e.g., wool and/or cotton microfibers released from textile articles during the washing thereof).

FIG. 1A is an exploded view of a filter assembly 100 in accordance with a first exemplary embodiment of the present invention. FIG. 1B is a sectional view of the filter assembly 100 in a first operating condition along a median sectional plane containing a vertical axis of the filter assembly 100. FIG. 1C is a sectional view of the filter assembly 100 in a second operating condition along the same sectional plane as FIG. 1B.

In the following, only those components of the filter assembly 100 deemed relevant to an understanding of the exemplary embodiment will be described.

In the following, directional terminology will be used—including terms such as above, below, in front, behind, central, lateral, upper, lower, . . . —only to describe the filter assembly 100 according to a specific orientation of use thereof. The directional terminology used should therefore in no way be understood as absolute terminology. In particular, the directional terminology used herein will refer to the three orthogonal directions X, Y, Z which identify, respectively, a longitudinal direction, a transverse direction, and a vertical direction. According to the exemplary embodiment of the invention, the plane containing the X and Y directions identifies a rest surface (such as a floor) on which an appliance for washing laundry or textile articles according to the invention with which the filter unit 100 is associated lies during its operation.

According to the exemplary embodiment, the filter assembly 100 comprises a filtering element 105.

According to the exemplary embodiment, the filtering element 105 comprises a filtering surface. According to the exemplary embodiment, such filtering surface comprises, for example, a mesh 105(M), such as a possibly woven wire structure defining an open weave provided with uniformly spaced apertures. The filtering element 105, and particularly the mesh 105(M), may comprise a flexible material, which permits easy manipulation during cleaning operations. Without loss of generality, the mesh 105(M) may be made of polyethylene or metallic material.

According to the exemplary embodiment, the mesh 105(M) has a size (hereinafter referred to as the mesh size) such that it retains particles having a minimum size between 0.1 μm and 5 mm, preferably a minimum size between 10 μm and 100 μm, and more preferably a minimum size between 10 μm and 75 μm. According to the exemplary embodiment, the mesh size corresponds to the size of the apertures defined by the mesh.

This mesh size allows the filtration from a washing fluid of contaminants smaller than 5 mm, such as microplastic elements, such as, for example, microfilaments that detach from synthetic fabrics during a washing treatment, and/or lint, such as, for example, wool and/or cotton microfibres from textile articles treated by the laundry or textile articles washing appliance contained in the liquid.

In accordance with the exemplary embodiment, the filtering element 105 comprises a frame 105(F) (e.g., a rigid or semi-rigid frame) to provide structural strength to the filtering element 105. Without loss of generality, the frame 105(F) may be made of plastic, i.e., polymeric, or metallic material.

In accordance with the exemplary embodiment, the frame 105(F) comprises horizontal and vertical frame portions that delimit a plurality of openings that expose respective portions of the mesh 105(M).

According to the exemplary embodiment, the filtering element 105 has a general tubular shape. According to the exemplary embodiment, therefore, the filtering element 105 constitutes a so-called cartridge.

According to the exemplary embodiment, the filtering element 105 encloses an inlet chamber 110 suitable for receiving (from the laundry or textile articles washing appliance) the fluid to be filtered.

According to the exemplary embodiment, the inlet chamber 110 corresponds to the internal, in particular cylindrical, volume of the filtering element 105.

In accordance with the exemplary embodiment, a main dimension of the inlet chamber 110 extends along the Z direction, or, in other words, the major extent of the inlet chamber 110 is along the Z direction. This results in a generally vertical orientation of the filter assembly 100. For this reason, the filter assembly 100 illustrated in FIGS. 1A-1C will also be referred to as a vertical filter assembly to distinguish it from embodiments of the present invention wherein the major extent of the inlet chamber 110 is along a horizontal direction, i.e., perpendicular to the Z direction.

In accordance with the exemplary embodiment, the filter assembly 100 comprises an inlet IN (visible in FIG. 1A) through which fluid is supplied to the inlet chamber 110.

According to the exemplary embodiment, the inlet IN of the filter assembly 100 is adapted to be coupled to a conduit C of the laundry or textile washing appliance to receive the fluid to be filtered therefrom. For example, the conduit C may be part of a fluid recirculation system of the laundry or textile articles washing appliance configured to cyclically recirculate fluid in the appliance by taking it from a region of a hydraulic circuit and returning it to the same region, or the conduit C may be part of a drain system of the appliance configured to discharge the fluid into a drain external to the appliance.

In accordance with the exemplary embodiment, the filter assembly 100 includes an inlet channel (not visible in the figures) for channeling fluid from the inlet IN to the inlet chamber 110. In a normal operating condition of the filter assembly 100, the fluid is supplied, in particular through the conduit C, the inlet IN and the inlet channel to the inlet chamber 110 and it is then filtered by passing through the filtering surface, i.e. the mesh 105(M), of the filtering element 105.

The flow of the fluid reaching the inlet chamber 110 through the inlet IN is graphically indicated in FIG. 1B by the arrow identified with the reference F1.

In accordance with the exemplary embodiment, the filter assembly 100 includes a filter housing 115 adapted to house the filtering element 105.

According to the exemplary embodiment, the filter housing 115 has a generally tubular shape, such as a generally cylindrical shape.

According to the embodiment, the filter assembly 100 includes an outlet chamber 120 (visible in FIGS. 1B-1C) defined by a volume between the filtering element 105 and the filter housing 115 when the filtering element 105 is housed in the filter housing 115. The outlet chamber 120 receives the filtered fluid resulting from the passage of the fluid from the inlet chamber 110 through the filtering surface of the filtering element 105.

In the embodiment considered, in which the filtering element 105 and the filter housing 115 have a generally tubular shape, the outlet chamber 120 has a generally hollow cylindrical shape.

The flow of fluid reaching the outlet chamber 120 passing through the filtering surface of the filtering element 105 is indicated in FIG. 1B by the arrows identified with the reference F2. In accordance with the exemplary embodiment, the filter assembly 100 includes an outlet OUT (visible in FIGS. 1B and 1C) through which the filtered fluid from the outlet chamber 120 is discharged.

In accordance with the exemplary embodiment, the outlet OUT of the filter assembly 100 is adapted to be coupled to a conduit C′ of the appliance to supply the filtered fluid outside the filter assembly 100. For example, the conduit C′ may be part of a fluid recirculation system of the laundry or textile articles washing appliance configured to recirculate the filtered fluid in the appliance or the conduit C′ may be part of a drain system of the laundry or textile articles washing appliance configured to discharge the filtered fluid into a drain external to the appliance.

According to the exemplary embodiment, the filter assembly 100 comprises an outlet channel OUT (CH) (visible in FIGS. 1B-1C) to convey the filtered fluid from the outlet chamber 120 to the outlet OUT and then, through the conduit C′, such filtered fluid is recirculated in the appliance for washing laundry or textile articles (discharged into a drain external to the appliance).

The flow of filtered fluid exiting the outlet chamber 120 through the outlet channel OUT (CH) and the outlet OUT is graphically indicated in FIG. 1C by the arrow identified with the reference F3.

According to the exemplary embodiment, the filter assembly 100 comprises a filter head 125. According to the exemplary embodiment, the filter head 125 is adapted to at least partially close, from above, the filter housing 115.

According to the exemplary embodiment, the filter head 125 comprises a body 125(B).

According to the exemplary embodiment, the filter head 125 comprises a cover 125(C) configured to close the body 125(B) from above.

According to the exemplary embodiment, the cover 125(C) includes a handle portion 125(H) for handling the filter head 125.

In the exemplary embodiment, the cover 125(C) and the body 125(B) are mateable to each other, for example in a removable manner. Without loss of generality, the cover 125(C) and the body 125(B) are mateable to each other by means of snap connections and/or screws (not shown). In alternative embodiments, the cover 125(C) and the body 125(B) may be made in a single piece.

According to the exemplary embodiment, the filter element 105 and the filter head 125 are mateable to each other in a removable manner.

According to the exemplary embodiment, the body 125(B) comprises, for example, in a lower portion thereof, one or more respective retention elements 125(R), and the filtering element 105 comprises, for example, in an upper end thereof, a collar 105(C) provided with respective retention elements 105(R). According to the exemplary embodiment, the filtering element 105 and the filter head 125 are mateable with each other by means of a bayonet connection, for example by inserting the collar 105(C) of the filtering element 105 into the body 125(B), and rotating the filter head 125, or only the body 125(B), when the cover 125(C) and the body 125(B) are decoupled from each other, around their axis so that the retaining elements 105(R), 125(R) come into contact with each other and corresponding retaining surfaces engage each other.

According to the exemplary embodiment, the body 125(B) houses within it the inlet channel (not visible in the figures) for channeling the fluid from the inlet IN to the inlet chamber 110 when the filter head 125 is connected to the filter housing 115.

In accordance with the exemplary embodiment, the filter assembly 100 includes a filter base 130.

According to the exemplary embodiment, the filter base 130 has the shape of a cup (or lid, or cap) that inferiorly delimits a hollow space.

In accordance with the exemplary embodiment, the filter base 130 is adapted to be removably coupled to a lower portion of the filtering element 105. For example, the filter base 130 is coupled to the filtering element 105 by snap connections, bayonet connections, or tightening elements such as screws. The filter base 130 may also be coupled to the filtering element 105 by threaded coupling elements, preferably provided on both the filter base 130 and the filtering element 105 to allow the filter base 130 to be screwed onto the filtering element 105.

In the exemplary embodiment, the mating between the filter base 130 and the filtering element 105 defines a collection region 130(R) for collecting accumulations of debris, such as hair, scale, lint, and so on.

As will be described in greater detail in the following, in accordance with the exemplary embodiment, the collection region 130(R) may further act as a collection region for collecting contaminants, such as microplastics, removed from the filtering surface of the filtering element 105 by a cleaning system of the filtering element 105.

In accordance with the exemplary embodiment, the filter assembly 100 may comprise a fixation support 135 adapted to secure the filter housing 115 to a vertical wall, not shown in the figures. Without loss of generality, the fixation support 135 may be omitted in alternative embodiments, wherein the filter assembly may be configured to be freely positioned by the user, such as by placing it on the top cover of the outer casing of the laundry or textile article washing appliance. Alternatively, the filter assembly may be an internal component of the laundry or textile articles washing appliance itself.

According to the exemplary embodiment, the fixation support 135 can be fixed to the wall by means of suitable fixing devices (not shown), such as threaded screws.

According to the exemplary embodiment, the filter housing 115, or the filtering element 105, the filter housing 115, the filter head 125, and the filter base 130 in their assembled configuration, may be removably couplable to the attachment bracket 135, so as to be easily removable from the fixation support 135 when necessary, such as during cleaning operations.

According to the exemplary embodiment, the fixation support 135 comprises an upper engaging member 135(U) adapted to engage, for example by snap connections, an upper connector of the filter housing 115 (not illustrated), and a lower engaging member 135(L) adapted to engage, for example by snap connections, a lower connector of the filter housing 115 (not illustrated).

According to the exemplary embodiment, when the filter housing 115 is fixed to the fixation support 135, a cavity (not shown) is formed between a rear outer surface of the filter housing 115 and the fixation support 135 for the passage of the conduits C, C′ and their connections to the inlet IN and outlet OUT of the filter assembly 100.

In accordance with the exemplary embodiment, the filter assembly 100 includes a cleaning system operable to remove contaminants such as microplastics, from the filtering surface, i.e., the mesh 105(M) of the filtering element 105, that have accumulated over time as a result of the filtering of the fluid used by the laundry or textile articles washing appliance through such surface. In accordance with the exemplary embodiment, the cleaning system comprises a scraper device 140 housed in the inlet chamber 110.

According to the exemplary embodiment, the scraper device 140 is configured to be rotated, relative to the inlet chamber 110, about a rotation axis R parallel to the Z direction.

According to the exemplary embodiment, the scraper device 140 is configured to mechanically interact with (the inner side of) the filtering surface, i.e., the mesh 105(M), of the filtering element 105, in particular with the inner side of the filtering surface, so as to scrape the filtering surface of the filtering element 105 during rotation about the rotation axis R. As a result of the scraping action exerted by the rotation of the scraper device 104 within the inlet chamber 110, contaminants accumulated on the filtering surface are removed from the surface itself.

In accordance with the exemplary embodiment, the scraper device 140 is further configured to move the removed contaminants from the inlet chamber 110 to the collection region 130(R). In this manner, the removed contaminants are collected in the collection region 130(R). Since the filter base 130 is removable from the filtering element 105, the contaminants accumulated in the collection region 130(R) can then be easily extracted and properly disposed of, dramatically reducing the environmental impact thereof.

According to the exemplary embodiment, the scraper device 140 comprises an endless screw element, such as an Archimedean screw, comprising a blade 140(B), for example, a helical blade, which develops around a central support rod 140(S) integral therewith and extending along the rotation axis R. In other embodiments, instead of a blade or in addition to it, the scraper device 140 may be provided with brush elements which interact mechanically with the filtering surface 105(M).

In the exemplary embodiment, rotation of the scraper device 140 is achieved by rotating the rod 140(S), which rotation causes a consequent rotation of the blade 140(B) associated with the rod 140(S). The filtering surface of the filtering element 105 is then scraped by the blade 140(B), which during rotation mechanically interacts with such surface. Contaminants removed from the filtering surface of the filtering element 105 by the scraping action of the blade 140(B) are further guided towards the collection region 130(R) by the helical shape of the blade 140(B) itself during rotation.

According to the exemplary embodiment, the filter assembly 100 comprises an electric motor M configured to rotate the scraper device 140 about the rotation axis R.

According to the exemplary embodiment, the electric motor M is installed in a motor housing 145 located in a lower portion of the filter housing 115 delimited along the Z direction by two walls 147, 148.

According to the exemplary embodiment, the wall 147 supports the electric motor M at the bottom. The wall 147 can be removably coupled to the filter housing 115, for example, by snap-fit, bayonet-fitting elements, or by tightening screws, so as to allow access to the motor housing 145, for example to inspect the electric motor M.

According to the exemplary embodiment, the wall 148 covers the electric motor M from above along the direction Z. When the filtering element 105 is housed in the filter housing 115, the wall 148 is therefore positioned between the lower portion of the filter element 105 (in particular, the filter base 130) and the electric motor M.

According to the exemplary embodiment, the electric motor M comprises a drive shaft M(S) configured to be rotatably coupled to the rod 140(S) of the scraper device 140—when the filtering element 105 is housed in the filter housing 115 through a hole 149A (visible in FIG. 1A) made in the wall 148 and through a hole 149B (visible in FIG. 1B) made in the filter base 130. In this way, when the filtering element 105 is housed in the filter housing 115, the rotation of the drive shaft M(S) is transmitted to the rod 140(S), and therefore the scraper device 140 rotates about the rotation axis R.

According to the exemplary embodiment, the scraper device 140 is configured to be movable relative to the filtering element 105 along the rotation axis R.

In this regard, according to the exemplary embodiment, the filter assembly 100 comprises a first guide element 150 and a second guide element 160 (visible in FIGS. 1B-1C) coupled or coupleable with the filtering element 105 and capable of slidingly engaging, along the rotation axis R, a first end 165 and a second end 170, respectively, of the scraper device 140.

According to the exemplary embodiment, the first guide element 150 is a sleeve located in a central portion of the body 125(B) of the filter head 125 and defining a cylindrical cavity extending along the rotation axis R.

According to the exemplary embodiment, the first end 165 of the scraper device 140 comprises an upper end of the rod 140(S) suitable for being engaged in the first guide element 150.

According to the exemplary embodiment, the second guide element 160 is a sleeve located in a central portion of the filter base 130, and defining a cylindrical cavity extending along the rotation axis R. According to the exemplary embodiment, the second guide element 160 is arranged such that the cylindrical cavity of the second guide element 160 is arranged coaxially to the bore 149B of the filter base 130.

According to the exemplary embodiment, the second end 170 of the scraper device 140 comprises a lower end of the rod 140(S) adapted to be engaged in the second guide element 160. The lower end of the rod 140(S) is further configured to rotatably couple to the drive shaft M(S) of the electric motor M to enable the aforementioned rotational transmission between the drive shaft M(S) and the rod 140(S).

When the first end 165 of the scraper device 140 is housed in the first guide element 150 and the second end 170 is housed in the second guide element 160, the scraper device 140 is then free to rotate about the rotation axis R and at the same time to translate along the rotation axis R. According to the exemplary embodiment, the extensions, along the rotation axis R, of the cylindrical cavities defined by the guide elements 150 and 160 are appropriately configured so as to prevent the ends 165, 170 of the rod 140(S) from coming out of the respective guide elements 150 and 160 as a result of translation along the rotation axis R as long as the filter head 125 remains coupled to the filter housing 115.

According to the exemplary embodiment, the scraper device 140 is configured to be moved, relative to the filtering element 105 and within the guide elements 150, 160, along the rotation axis R by a pushing action exerted by the contaminants accumulated in the collection region 130(R) of the filtering element 105.

In particular, when the contaminants accumulated in the collection region 130(R) are in such an amount as to reach, starting from the bottom of the collection region 130(R), i.e. starting from the bottom surface of the filter base 130, the lower end of the blade 140(B), i.e. the terminal end of the blade 140(B) proximal to the lower end of the rod 140(S), such an amount of contaminants can exert an upward thrust action. Such thrust action is directed in the direction of a reaction force exerted by the contaminants on the lower end of the blade 140(B) in reaction to the thrust, in particular directed downwards, exerted by the lower portion of the blade 140(B), the thrust action exerted by the contaminants is such as to push the scraper device 140, along the rotation axis R, towards the filter head 125.

FIG. 1B illustrates the filter assembly 100 with the scraper device 140 in a start-of-stroke condition (or lowered condition), where the scraper device 140 has the second end 170 which is supported on corresponding support elements 175 formed on the filter base 130. This condition corresponds to the case where the collection region 130(R) does not contain contaminants, or the amount of contaminants present in the collection region 130(R) is not sufficient to cause a displacement of the scraper device 140 (along the rotation axis R) towards the filter head 125. In the exemplary embodiment, the scraper device 140 is configured such that, in the start-of-stroke condition, the lower end of the blade 140(B) is at least partially included in the collection region 130(R), i.e., it is at such a height (along the Z direction) that it is at least partially included in the volume enclosed by the filter base 130. It is particularly advantageous to provide a scraper device 140 that, when mounted in the filter assembly 100 and in the condition in which the collection region 130(R) is empty, i.e. not containing contaminants, extends inside the collection region for a length, measured along the rotation axis R, of between 1 mm and 10 mm, preferably of between 1 mm and 5 mm. According to a further sizing procedure of the scraper device 140, its shape can be defined in such a way that, when the scraper device 140 is mounted in the filter assembly 100, and in the condition in which the collection region 130(R) is empty, i.e. not containing contaminants, the volume occupied by the scraper device 140, within the collection region 130(R) is between 5% and 25% of the volume of the collection region 130(R), preferably between 5% and 15% of the volume of the collection region 130(R), more preferably between 5% and 10% of the volume of the collection region 130(R). The different size ranges or percentage ranges defined above for the linear penetration of the scraper device 140 into the collection region 130(R) or for the percentage of volume occupancy of the collection region 130(R) by the scraper device 140 may be applied based on the desired sensitivity of sensing of the displacement of the scraper device 140 along its rotation axis R caused by the accumulation of contaminants in the collection region 130(R).

FIG. 1C illustrates the filter assembly 100 with the scraper device 140 in a raised condition, where the scraper device 140 has been pushed towards the filter head 125 by the presence of a sufficient amount of contaminants accumulated in the collection region 130(R), and the second end 170 no longer rests on the support members 175.

The amount of contaminants accumulated in the collection region 130(R) required to push, in particular towards the filter head 125, the scraper device 140 along the rotation axis R may depend on one or more of the following factors:
the geometry of the collection region 130(R), that is, of the filter base 130;
the geometry of the scraper device 140, and in particular of the lower end of the blade 140(B);
the distances between the bottom of the collection region 130(R) and the lower end of the blade 140(B) of the scraper device 140.

In the exemplary embodiment illustrated in FIGS. 1A-1C, the collection region 130(R) is shaped in such a way as to allow for an accumulation of contaminants that does not initially generate any pushing action on the scraper device 140, since the contaminants initially accumulate along peripheral portions of the filter base 130 which are distant, both in the Z direction and in the X and Y directions, from the lower end of the blade 140(B). In this exemplary embodiment, the pushing action on the scraper device 140 can only occur following a sufficient accumulation of contaminants in the collection region 130(R) such that the accumulated mass of contaminants actually reaches the lower end of the blade 140(B).

Other configurations are possible, in which the collection region 130(R) and the scraper device 140 are shaped in such a way that the scraper device 140 is subjected to a pushing action as soon as contaminants reach the collection region 130(R). For example, the scraper device 140 may be equipped with a blade 140(B) that extends downwards until it touches/grazes, in the start-of-stroke condition, the bottom of the collection region 130(R) where the contaminants removed from the filtering surface of the filtering element 105 firstly accumulate.

It is also emphasized that the amount of contaminants accumulated in the collection region 130(R) required to push the scraper device 140, in particular towards the filter head 125, can be influenced by the characteristics of the accumulated contaminants, such as for example one or more of:
size of contaminant particles;
shape of contaminant particles;
overall shape of the accumulated mass of contaminants;
degree of compactness of the mass of accumulated contaminants;
moisture absorbed by contaminants;
presence of encrusted portions in the mass of accumulated contaminants.

For example, the mass of contaminants accumulated in the collection region 130(R) may not be able to exert a sufficient reaction for a pushing action on the scraper device 140 if such a mass is not sufficiently compact. For this reason, before the mass of contaminants accumulated in the collection region 130(R) can be able to push the scraper device 140, it may be necessary for a greater quantity of contaminants to accumulate in the collection region 130(R), and for the subsequent compaction of the same, for example exerted by the scraper device 140, and in particular by the action exerted by the blade 140(B) of the scraper device 140 on the mass of accumulated contaminants.

The pushing action exerted by the contaminants accumulated in the collection region 130(R) on the scraper device 140 can generally vary over time due to the variation in the shape of the mass of contaminants accumulated in the collection region 130(R). Such variation can be caused not only by the introduction of new contaminants removed from the filtering surface of the filtering element 105, but also due to the interaction between the blade 140(B) and the mass of contaminants accumulated in the collection region 130(R) during the rotation of the scraper device 140 and the consequent mixing of the accumulated contaminants.

Furthermore, the compactness/hardness of the mass of contaminants accumulated in the collection region 130(R), and therefore the ability of the latter to exert a pushing action on the scraping device 140, can be influenced by the humidity absorbed by the mass of contaminants given by the passage of the appliance fluid within the filtering element 105.

According to the exemplary embodiment, the filter assembly 100 includes a position sensor system configured to sense the position of the scraper device 140 along the rotation axis R and generate a corresponding position signal PS indicative of the sensed position.

According to the exemplary embodiment, the position sensor system comprises:
magnetic elements 190 integral with the scraping device 140, and
a sensor 195 integral with the filtering element 105, configured to measure the intensity of the magnetic field generated by the magnetic elements 190 and to generate the position signal PS.

The magnetic elements 190, being integral with the scraper device 140, move together with the scraper device 140 along the rotation axis R when the scraper device 140 is pushed by the contaminants accumulated in the collection region 130(R). The more the scraper device 140 is displaced, in particular towards the filter head 125, the greater the distance between the magnetic elements 190 and the sensor 195, and, consequently, the lower the magnetic field intensity measured by the sensor 195. In general, the magnetic field strength measured by the magnetic field sensor 195 has a maximum value when the scraper device 140 is in the start-of-stroke condition (FIG. 1B), and takes a value less than the maximum value when the scraper device 140 is in a raised condition (FIG. 1C), with this value decreasing as the position of the scraper device 140 moves from its position in the start-of-stroke condition.

According to the exemplary embodiment, the sensor 195 is configured to generate the position signal PS based on the measured magnetic field strength. Without loss of generality, the position signal PS may be an analog signal, e.g., directly or inversely proportional to the measured magnetic field strength, or a digital signal.

In accordance with the exemplary embodiment, the magnetic elements 190 are located at the second end 170 of the scraper device 140, e.g. coupled to or connected to the lower end of the rod 140(S).

According to the exemplary embodiment, the sensor 195 is located at the wall 148 above the electric motor M, for example housed in a respective seat made in the wall 148.

The positions of the magnetic elements 190 and the sensor 195 may however be different, for example with the magnetic elements 190 integral with the filter element 105 and the magnetic field sensor integral with the scraper device 140.

Other types of position sensor systems may be used to sense the position of the scraper device 140 along the rotation axis R, such as capacitive, inductive, optical, piezoelectric position sensor systems, devices equipped with encoders, or potentiometers.

According to the exemplary embodiment, the filter assembly 100 comprises an output system, schematically illustrated in FIGS. 1B and 1C with reference 196, configured to receive the position signal PS and to output, based on the received position signalPS, a filter indication IND comprising one or more of the following indications:
An indication regarding the amount of contaminants accumulated in the collection region 130(R), where such an amount is calculated on the basis of the value of the position signal PS, and hence of the actual position of the scraping device 140 along the rotation axis R.
An indication regarding the filling (of contaminants) condition of the collection region 130(R), e.g. in terms of predefined levels (e.g. “empty”, “half full”, “full”) each corresponding to a respective predefined range of values of the position signal PS and thus, e.g., to a respective range of positions of the scraper device 140 along the rotation axis R.
An indication of the need to empty the collection region 130(R), generated, for example, when the position signal PS has reached a predefined threshold value corresponding to a predefined position of the scraper device 140 along the rotation axis R.

The filter indication IND provided by the output system 196 may be provided in the form of visual indications, for example by the illumination of appropriate lamps (not shown) or the display of messages on display elements such as displays (not shown).

The filter indication IND provided by the output system 196 may also, or instead, be provided in the form of audible indications, such as through the generation of audio alerts.

The filter indication IND provided by the output system 196 may also, or instead, be provided in the form of a signal (digital or analog) to be sent to an external device, such as a smartphone equipped with an appropriate application capable of interacting with the output system 196, or to be sent to a control unit of the laundry or textile articles washing appliance to which the filter assembly 100 is hydraulically connected.

According to another embodiment not illustrated, the output system 196 can be external to the filter assembly 100, for example located at the laundry or textile articles washing appliance to which the filter assembly 100 is hydraulically connected, and communicatively coupled with the position sensor system, for example, with the sensor 195, of the filter assembly 100 to receive the position signal PS.

In accordance with the exemplary embodiment, the filter assembly 100 includes a biasing member associated with the scraper device 140 and configured to counteract the pushing action exerted on the scraper device 140 by contaminants accumulated in the collection region 130(R) of the filtering element 105.

In accordance with the exemplary embodiment, the biasing element comprises a spring SE located in the filter head 125 and provided to push the scraper device 140 away from the filter head 125 along the rotation axis R.

According to the exemplary embodiment, the spring SE is positioned at least partially inside the first guide element 150 coaxially with the scraper device 140, and in particular with the rod 140(S).

In accordance with the exemplary embodiment, the spring SE is configured to contact the first end 165 of the scraper device 140.

According to the exemplary embodiment, when the scraper device 140 is in the (lowered) start-of-stroke condition illustrated in FIG. 1B, the pushing action towards the filter base 130 exerted by the spring SE on the scraper device 140 is such as to keep the second end 170 of the scraper device 140 firmly abutting the support elements 175 of the filter base 130. In this way, unwanted oscillations of the scraper device 140 along the rotation axis R are advantageously avoided, or significantly reduced, which would lead to uncontrolled oscillations of the position signal PS and therefore to incorrect evaluations of the quantity of contaminants accumulated in the collection region 130(R).

According to the exemplary embodiment, in order to cause the scraper device 140 to move from the (lowered) start-of-stroke condition illustrated in FIG. 1B to a raised condition such as that illustrated in FIG. 1C, the pushing action exerted by the contaminants accumulated in the collection region 130(R) must be strong enough to overcome the counter-push exerted by the spring SE.

According to the exemplary embodiment, the filter assembly 100 further comprises a flooding chamber 198 separated from the inlet chamber 110 and in fluid connection with the outlet chamber 120.

In the exemplary embodiment, the flooding chamber 198 is located above, along the Z direction, the inlet chamber 100. For example, the flooding chamber 198 is part of the body 125(B) of the filter head 125.

According to the exemplary embodiment, the filter assembly 100 includes an emergency fluid connection device for selectively enabling and disabling a fluid connection (hereinafter, emergency fluid connection) between the inlet chamber 110 and the flooding chamber 198 based on a condition of the inlet chamber 110, e.g., the pressure of the fluid contained in the inlet chamber 110. Hereinafter, whenever the term “emergency fluid connection” is mentioned, it means the fluid connection or fluid communication, i.e., the ability or capacity of fluid to pass or flow, between the inlet chamber 110 and the flood chamber 198.

According to the exemplary embodiment, the emergency fluid connection device is configured to allow emergency fluid connection in the presence of a blockage of the inlet chamber 110, thereby allowing unfiltered fluid to flow to the outlet OUT. This helps to avoid interruption of fluid flow by the clogged filter assembly 100, and thus prevents malfunction of the laundry or textile washing equipment connected thereto. Furthermore, fluid is prevented from overflowing from the filter assembly 100 and falling onto the floor, thereby flooding the room in which the laundry or textile articles washing appliance is located.

According to the exemplary embodiment, the emergency fluid connection device comprises a movable body EDB (hereinafter referred to as emergency movable body) configured to take a closed position and an open position to disable or enable, respectively, the emergency fluid connection by closing/opening an opening O located on a wall separating the inlet chamber 110 and the flooding chamber 198.

According to the exemplary embodiment, the enabling of the emergency fluid connection by the emergency movable body EDB occurs in the presence of a blockage of the inlet chamber 100 to allow the fluid to flow from the inlet IN to the flooding chamber 198 and, then, to the outlet OUT, through the inlet chamber 110 passing through the opening O, and the disabling of the emergency fluid connection by the emergency movable body EDB occurs when there is no blockage of the inlet chamber 110 to separate, from the fluid dynamic point of view, the flooding chamber 198 from the inlet chamber 110.

According to the exemplary embodiment, the emergency movable body EDB is located above the opening O, and is movable relative to the filter housing 115 and the body 125(B) of the filter head 125 along the vertical direction Z.

According to the exemplary embodiment, the emergency movable body EDB takes the open position by moving upwards and freeing the opening O due to the pressure exerted on the emergency movable body EDB by the fluid accumulated in the inlet chamber 110 when the inlet chamber 110 is in a clogged condition, i.e. when the fluid is no longer able to pass through the filtering surfaces of the filtering element 105.

According to the exemplary embodiment, the emergency movable body EDB takes the closed position, occluding the opening O, when the inlet chamber 110 is in an unclogged condition, i.e. when the fluid is able to pass through the filtering surfaces of the filtering element 105, and therefore the pressure exerted on the emergency movable body EDB by the fluid accumulated in the inlet chamber 110 is not sufficient to overcome the gravitational force acting on the emergency movable body EDB.

In the exemplary embodiment, a position sensor (not shown) may detect the position of the emergency movable body EDB, and notify the output system 196 of that position. In this manner, the output system 196 may report a clogged filter condition when the detected position of the emergency movable body EDB corresponds to the open position.

It is emphasized that the concepts of the present invention can however be applied to the case where the flooding chamber 198 and the emergency fluid connection device comprising the movable body EDB are not present.

FIGS. 2A and 2B are two sectional views along two different sectional planes that include the rotation axis R of a filter assembly 200 in accordance with a second exemplary embodiment of the present invention.

The filter assembly 200 is structurally and functionally analogous to filter assembly 100. Accordingly, features, implementations, generalizations, examples and variants of the filter assembly 200, and its components or parts, which are present in filter assembly 100, are identified with the same references and will not be discussed further.

According to the exemplary embodiment, the filter assembly 200 comprises the filtering element 105 enclosing the inlet chamber 110, provided with filtering surface, and the filter housing 115, and the outlet chamber 120 defined by the volume between the filtering element 105 and the filter housing 115.

In the exemplary embodiment, the filter assembly 200 includes the inlet (visible in FIG. 2A) through which fluid is supplied to the inlet chamber 110, and the outlet (visible in FIG. 2A) through which fluid, filtered, is discharged from the outlet chamber 120. Also visible in FIG. 2A is the inlet channel, identified with the reference IN (CH), which was not visible in FIGS. 1A-1C relating to the filter assembly 100, for channeling the fluid from the inlet IN to the inlet chamber 110.

According to the exemplary embodiment, the filter assembly 200 comprises the filter head 125 which houses, among other things, the inlet channel IN (CH).

According to the exemplary embodiment, the filter assembly 200 comprises the filter base 130, the coupling of which with the filtering element 105 defines the collection region 130(R).

In accordance with the exemplary embodiment, the filter assembly 200 includes the fixation support 135 for fixing the filter housing 115 to a vertical wall.

According to the exemplary embodiment, the inlet chamber 110 comprises a first inlet chamber portion 210, or main inlet chamber, and a second inlet chamber portion 220, or auxiliary inlet chamber.

According to the exemplary embodiment, the main inlet chamber 210 is in fluid communication with the inlet IN to receive the fluid to be filtered. According to the exemplary embodiment, the main inlet chamber 210 corresponds to the lower portion, along the Z direction, of the inlet chamber 110 coupled to the filter base 130.

According to the exemplary embodiment, the auxiliary inlet chamber 220 is located above, along the Z direction, the main inlet chamber 210, and corresponds to the upper portion, along the Z direction, of the inlet chamber 110, i.e. the portion thereof closest to the filter head 125.

In accordance with the exemplary embodiment, the auxiliary inlet chamber 220 is separated from the main inlet chamber 210 by a separation wall 230 that extends substantially perpendicular to the Z direction within the inlet chamber 110. In other words, the main inlet chamber 210 and the auxiliary inlet chamber 220 are defined by partitioning the inlet chamber 110 into two distinct portions by means of the separation wall 230.

In accordance with the exemplary embodiment, the filter assembly 200 comprises a cleaning system comprising a scraper device 240 in the inlet chamber 110, similar to the scraper device 140 of the filter assembly 100, but located only within the main inlet chamber 210, and configured to be rotated by the electric motor M about the rotation axis R so as to scrape the filtering surface of the portion of the filtering element 105 corresponding to the main inlet chamber 210, to remove accumulated contaminants therefrom, and to move the removed contaminants to the collection region 130(R).

Similarly to the scraper device 140 of the filter assembly 100, the scraper device 240 according to the exemplary embodiment comprises an endless screw element, such as an Archimedean screw, comprising a blade 240(B), for example, a helical blade, which develops around a central support rod 240(S) integral therewith and extends along the rotation axis R. In other embodiments, instead of a blade, or in addition to it, the scraper device 240 may be provided with brush elements that interact mechanically with the filtering surface.

Similarly to the scraper device 140 of the filter assembly 100, the scraper device 240 is configured to be movable relative to the filtering element 105 along the rotation axis R.

In this regard, according to the exemplary embodiment, the filter assembly 200 comprises a first guide element 250 and a second guide element 260 coupled or coupleable with the filtering element 105 and adapted to slidably engage-along the rotation axis R-a first end 265 and a second end 270, respectively, of the scraper device 240.

According to the exemplary embodiment, the first guide element 250 is a sleeve located in a central portion of the separation wall 230 and defining a cylindrical cavity that extends along the rotation axis R, i.e. perpendicularly to the separation wall 230 itself.

According to the exemplary embodiment, the first end 265 of the scraper device 240 comprises an upper end of the rod suitable for being engaged in the first guide element 250.

According to the exemplary embodiment, the second guide element 260 is a sleeve located in a central portion of the filter base 130, and defining a cylindrical cavity extending along the rotation axis R.

According to the exemplary embodiment, the second end 270 of the scraper device 240 comprises a lower end of the rod adapted to be engaged in the second guide member 260. The lower end of the rod is further configured to rotatably couple to the drive shaft of the electric motor M to enable rotational transmission between the drive shaft of the electric motor M and the rod of the scraper device 240.

When the first end 265 of the scraper device 240 is housed in the first guide element 250 and the second end 270 is housed in the second guide element 260, the scraper device 240 is then free to rotate about the rotation axis R and at the same time to translate along the rotation axis R. Similarly to the scraper device 140 of the filter assembly 100, according to the exemplary embodiment, the scraper device 240 is configured to be moved, relative to the filtering element 105 and within the guide elements 250, 260, along the rotation axis R by a pushing action exerted by the contaminants accumulated in the collection region 130(R) of the filtering element 105.

FIGS. 2A and 2B illustrate the filter assembly 200 with the scraper device 240 in a raised condition, where the scraper device 240 has been pushed toward the filter head 125 by the presence of a sufficient amount of contaminants accumulated in the collection region 130(R).

According to the exemplary embodiment, the filter assembly 200 comprises a position sensor system configured to sense the position of the scraper device 240 along the rotation axis R and generate a corresponding position signal PS indicative of the sensed position. In a manner similar to the scraper device 140 of the filter assembly 100, the position sensor system comprises magnetic elements 190 integral with the scraper device 240, and a sensor (not visible in FIGS. 2A and 2B) integral with the filtering element 105, configured to measure the intensity of the magnetic field generated by the magnetic elements 190 and to generate the position signal PS. Similarly to the filter assembly 100, according to the exemplary embodiment, the filter assembly 200 comprises the output system 196, configured to receive the position signal PS and to output, based on the received position signal PS, a filter indication IND comprising one or more of
an indication of the amount of contaminants accumulated in the collection region 130(R);
an indication regarding the filling (of contaminants) condition of the collection region 130(R);
an indication of the need to empty the collection region 130(R).

In accordance with the exemplary embodiment, the filter assembly 200 includes an auxiliary fluid connection device for selectively enabling and disabling a fluid connection, hereinafter, auxiliary fluid connection, between the main inlet chamber 210 and the auxiliary inlet chamber 220, based on a condition of the main inlet chamber 210, for example, the pressure of the fluid contained in the main inlet chamber 210. Hereinafter, whenever the term “auxiliary fluid connection” is mentioned, it will be understood as referring to the fluid connection or fluid communication, i.e., the ability or capacity of the fluid to pass or flow between the main inlet chamber 210 and the auxiliary inlet chamber 220.

According to the exemplary embodiment, the auxiliary inlet chamber 220 is configured to receive fluid to be filtered from the inlet IN only when said auxiliary fluid connection is enabled.

According to the exemplary embodiment, the auxiliary fluid connection device is configured to allow the auxiliary fluid connection in the presence of a blockage of the main inlet chamber 210, thus allowing the unfiltered fluid present in the main inlet chamber 210 to reach the auxiliary inlet chamber 220 and flow towards the outlet OUT through the filtering surface of the auxiliary inlet chamber 220. This allows to continue to ensure, at least temporarily, and in particular as long as the auxiliary inlet chamber 220 is not blocked, a filtering of the fluid received from the inlet IN even when the main inlet chamber 210 is blocked.

Referring to FIG. 2B, according to the exemplary embodiment, the auxiliary fluid connection device comprises a movable body ADB, hereinafter referred to as the auxiliary movable body, configured to assume a closed position and an open position to disable or enable, respectively, the auxiliary fluid connection by closing/opening an opening H located on the separation wall 230 separating the main inlet chamber 210 and the auxiliary inlet chamber 220.

According to the exemplary embodiment, the enabling of the auxiliary fluid connection by the auxiliary movable body ADB occurs when there is a blockage of the main inlet chamber 210 to allow the fluid to flow from the inlet IN to the auxiliary inlet chamber 220 and then to the outlet OUT through the filtering surface of the auxiliary inlet chamber 220, through the main inlet chamber 210, passing through the opening H, and the disabling of the auxiliary fluid connection by the auxiliary movable body ADB occurs when there is no blockage of the main inlet chamber 210, so as to separate, from the fluid dynamic point of view, the main inlet chamber 210 from the auxiliary inlet chamber 220.

According to the exemplary embodiment, the auxiliary movable body ADB is located above the opening H, and is movable relative to the filter housing 115 along the vertical direction Z.

According to the exemplary embodiment, the auxiliary movable body ADB takes the opening position by moving upwards and freeing the opening H due to the pressure exerted on the auxiliary movable body ADB by the fluid accumulated in the main inlet chamber 210 when this chamber is in a clogged condition, i.e. when the fluid is no longer able to pass through the filtering surfaces of the filter element 105 corresponding to the main inlet chamber 210.

According to the exemplary embodiment, the auxiliary movable body ADB takes the closing position, occluding the opening H, when the main inlet chamber 210 is in an unclogged condition, i.e. when the fluid is able to pass through the filtering surfaces of the filtering element 105 at the main inlet chamber 210, and therefore the pressure exerted on the auxiliary movable body ADB by the fluid accumulated in the main inlet chamber 210 is not sufficient to overcome the gravitational force acting on the auxiliary movable body ADB.

According to the exemplary embodiment, a position sensor (not shown) may detect the position of the auxiliary movable body ADB, and notify the output system 196 of that position. In this manner, the output system 196 may report a clogged main inlet chamber 210 condition when the detected position of the auxiliary movable body ADB corresponds to the open position.

In accordance with the exemplary embodiment, the auxiliary inlet chamber 220 has a capacity such as to allow filtering of a quantity of fluid sufficient to complete an operating cycle of the laundry or textile articles washing appliance. In this way, even if clogging of the main inlet chamber 210 is detected at the beginning of an operating cycle of the laundry or textile articles washing appliance, such cycle can be concluded while still ensuring filtering of the fluid.

Similarly to the filter assembly 100, according to the exemplary embodiment, the filter assembly 200 includes a biasing element, including the spring SE, associated with the scraper device 240 and configured to counteract the pushing action exerted on the scraper device 240 by the contaminants accumulated in the collection region 130(R).

According to the exemplary embodiment, the filter assembly 200 comprises the flooding chamber 198 with an emergency movable body (not visible in the figure but similar to the emergency movable body EDB of the filter assembly 100) to selectively open/close an opening (not visible in the figure but similar to the opening O of the filter assembly 100) located on a wall that separates the inlet chamber 110 and the flooding chamber 198, and in particular that separates the auxiliary inlet chamber 220 and the flooding chamber 198.

According to the exemplary embodiment, the emergency fluid connection device is configured to allow emergency fluid connection between the inlet chamber 110 and the flooding chamber 198, and in particular between the auxiliary inlet chamber 220 and the flooding chamber 198, in the presence of a blockage of both the main and the auxiliary inlet chambers 210, 220, thus allowing unfiltered fluid to flow to the outlet OUT. This helps to avoid interruption of fluid flow by the clogged filter assembly 200, and thus prevents malfunction of the laundry or textile articles washing appliance connected thereto. Furthermore, fluid is prevented from overflowing from the filter assembly 200 and falling onto the floor, thus flooding the room in which the laundry or textile articles washing appliance is located.

According to the exemplary embodiment, and similarly to what has been described in relation to the filter assembly 100, the emergency movable body takes the opening position due to the pressure exerted on the emergency movable body by the fluid accumulated in the auxiliary inlet chamber 220 when the auxiliary inlet chamber 220 is in a clogged condition, this condition possibly occurring when the main inlet chamber 210 is also clogged, that is, when the fluid is no longer able to pass through the filtering surfaces of the filtering element 105 corresponding to the auxiliary inlet chamber 220.

According to the exemplary embodiment, the emergency movable body takes the closing position when the auxiliary inlet chamber 220 is in an unclogged condition, i.e. when the fluid is able to pass through the filtering surfaces of the filtering element 105 corresponding to the auxiliary inlet chamber 220, and therefore the pressure exerted on the emergency movable body by the fluid accumulated in the auxiliary inlet chamber 220 is not sufficient to overcome the gravitational force acting on the emergency movable body.

It should be noted that even for the filter assembly 200, the flooding chamber 198 and the emergency fluid connection device may however not be present.

In the exemplary embodiment shown in FIGS. 1A-1C and the exemplary embodiment shown in FIG. 2, the main dimension of the inlet chamber 110 extends along the Z direction, thereby resulting in a generally vertical orientation of the filter assembly 100 and the filter assembly 200.

However, as previously mentioned, embodiments are possible in which the prevailing extension of the inlet chamber 110 is along a horizontal direction, i.e. perpendicular to the Z direction.

For example, FIG. 3 is a sectional view of a filter assembly 300 in accordance with a third exemplary embodiment of the present invention, wherein the prevailing extension of the inlet chamber 110 is along the Y direction.

The filter assembly 300 is structurally and functionally similar to the filter assembly 100, and has only some differences with respect to the latter.

For example, in the embodiment shown in FIG. 3, the filtering element 105, and the filter base 130, can be accessed by removing a cover member 325 mateable to one end of the filter housing 115 proximal to the side of the filtering element 105 coupled to the filter base 130.

Furthermore, according to the exemplary embodiment, the filter head 125 is not present; According to the exemplary embodiment, the electric motor M is coupled to a distal end of the filter housing 115 at the side of the filtering element 105 coupled to the filter base 130.

According to the exemplary embodiment, the input IN extends parallel to the Y direction.

According to the exemplary embodiment, the filter housing 115 is provided with connection elements CE (only one visible in FIG. 3) for connecting the filter assembly 300 to the laundry or textile articles washing appliance that supplies the fluid to be filtered. For example, the substantially horizontal extension of the filter assembly 300 makes it particularly advantageous to install the filter assembly 300 directly inside the laundry or textile articles washing appliance itself.

Although not visible in FIG. 3, the filter assembly 300 may also comprise a flooding chamber similar to the flooding chamber 198 of the filter assembly 100. In this case, the emergency movable body for selectively enabling/disabling the emergency fluid connection between the inlet chamber 110 and the flooding chamber may advantageously be provided with a guiding device, for example, a bias element such as a spring, for the guided movement of the emergency movable body, in particular for disabling the emergency fluid connection, since the substantially horizontal extension of the filter assembly 300 may not allow the use of the force of gravity, as instead occurs for the emergency movable body EDB of the filter assembly 100 illustrated in FIGS. 1B and 1C.

Similarly, according to a further exemplary embodiment not illustrated, a filter assembly with a prevailing extension of the inlet chamber along the Y (i.e., horizontal) direction may have the inlet chamber comprising a main inlet chamber and an auxiliary inlet chamber, as in the filter assembly 200 illustrated in FIG. 2.

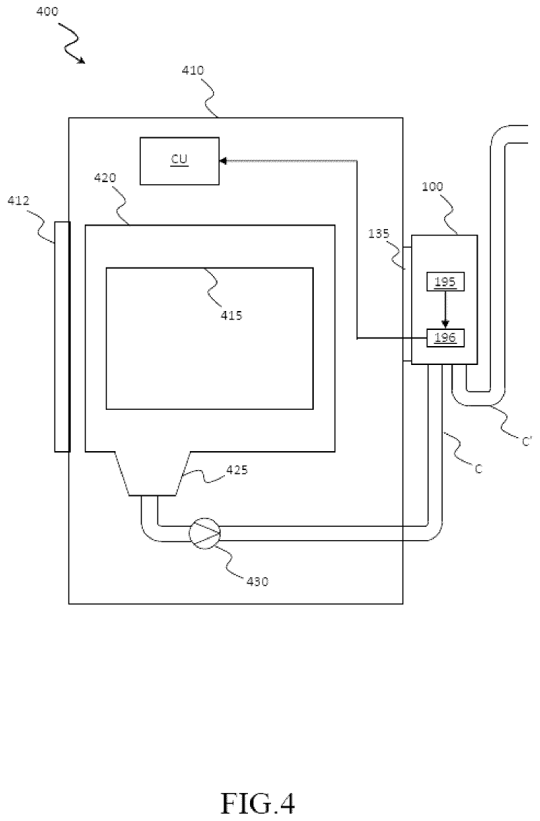

FIG. 4 schematically illustrates an example of how a filter assembly according to the exemplary embodiments described, for example the filter assembly 100 illustrated in FIGS. 1A-1C can be connected to a washing appliance of laundry or textile articles, in particular a washing machine 400, according to an exemplary embodiment.

According to the exemplary embodiment, the washing machine 400 comprises a casing 410 of substantially parallelepiped shape, containing hydraulic, electrical, mechanical, electronic, electromechanical components necessary for the operation of the washing machine 400. In FIG. 4, only the components necessary for understanding the installation of the filter assembly 100 and its use will be illustrated.

According to the exemplary embodiment, a door 412 formed on a front side of the casing 410 allows selective access to a rotating perforated basket 415, for example of substantially cylindrical shape, configured to receive textile articles (for example, clothes) to be treated, for example, washed or washed and dried.

According to the exemplary embodiment, the rotating basket 415 is housed in a washing tub 420, for example of a substantially hollow cylindrical shape, configured to receive fluids comprising water and/or water mixed with chemical treatment agents for textile products (detergents, fabric softeners, dyes, stain removers, . . . ).

According to the exemplary embodiment, the washing tub 420 includes in the bottom portion thereof a sump 425 configured to collect by gravity the fluids introduced into the washing tub 420.

In accordance with the exemplary embodiment, the laundry washing machine 400 includes a drain system for discharging fluid collected in the sump 425 into a drain external to the laundry washing machine 400.

In accordance with the exemplary embodiment, such discharge system comprises a pump 430 in fluid connection with the sump and configured, when operated, to move fluid collected in the sump 425 to a conduit such as the conduit C illustrated in FIG. 1A.

According to the exemplary embodiment, the filter assembly 100 is fixed to the washing machine 400, for example to the casing 410, via the fixing support 135 (see FIG. 1A), to receive the fluid to be filtered from the conduit C.

In accordance with the exemplary embodiment, referring jointly to FIGS. 1A-1C and 4, the conduit C is connected to the inlet IN of the filter assembly 100 to supply fluid (to be filtered) pumped through the conduit C into the filtering element 105; the fluid filtered by the filter assembly 100 is then supplied, through the outlet OUT, to the conduit C′ to be discharged into an external drain of the washing machine 400 (not illustrated).

Referring again to FIGS. 1A-1C and 4, according to the exemplary embodiment, the filter indication IND generated by the output system of the filter assembly 100 can also be advantageously provided, in the form of a digital or analog signal, to a control unit CU of the washing machine 400 coupled to exchange signals, for example by wired and/or wireless communication interface, with the output system 196 of the filter assembly 100.

According to an exemplary embodiment not illustrated, the output system 196 may instead be provided in a portion of the washing machine 400 itself and coupled to exchange signals, for example by means of a wired and/or wireless communication interface, to the sensor 195 of the filter assembly 100 to receive the position signal PS and to the control unit CU to provide the filter indication IND, in the form of an analog or digital signal.

In view of the above, the filter assembly 100 can be easily connected to any washing machine 400 to provide it with the capacity of filtering contaminants, such as, for example, microplastics, without having to carry out complex assembly operations. In fact, it is sufficient to connect the conduit C to the input IN of the filter assembly 100, connect the conduit C′ to the output OUT of the filter assembly 100, and communicatively couple, for example, by wiring or by wireless connection, the control unit CU with the position detection system of the filter assembly 100 and/or with the output system 196.

According to a further exemplary embodiment not illustrated, the output system 196 may be directly part of the control unit CU itself of the washing machine 400. In this case, the control unit CU is coupled to exchange signals, for example by wired and/or wireless communication interface, with the sensor 195 of the filter assembly 100 to receive the position signal PS.

In the exemplary embodiment illustrated in FIG. 4, the filter assembly 100 is connected in series to a drain system of the laundry washing machine 400 to filter the fluid that is drained from the laundry washing machine 400. According to another exemplary embodiment not illustrated, the filter assembly 100 may instead, or in addition, be connected to a fluid recirculation system of the laundry washing machine 400 configured to recirculate the fluid collected in the sump 425 in the washing tub 420 by sucking it from there and reintroducing it into the washing tub 420.

It is further emphasized that although in the exemplary embodiment illustrated in FIG. 4, the filter assembly connected to the washing machine 400 is the filter assembly 100 corresponding to the exemplary embodiment illustrated in FIGS. 1A-1C, the filter assembly connected to the washing machine 400 may be a filter assembly corresponding to the filter assemblies 200 or 300.

Furthermore, although in the exemplary embodiment illustrated in FIG. 4, the filter assembly is connected externally to the laundry washing machine 400, similar considerations apply in the case where the filter assembly is connected internally to the laundry washing machine 400, particularly in the case where, but not limited to this case, the filter assembly is installed to filter (at least) the fluid of a fluid recirculation system of the laundry washing machine 400.

Of course, to meet local and specific needs, one skilled in the art may make numerous logical and/or physical modifications and alterations to the invention described above. More specifically, while the present invention has been described with a certain degree of particularity with reference to preferred embodiments thereof, it is to be understood that various omissions, substitutions, and modifications in form and detail as well as other embodiments are possible. In particular, various embodiments of the invention may also be practiced without the specific details set forth in the foregoing description to provide a more thorough understanding thereof; conversely, known features may have been omitted or simplified so as not to burden the description with unnecessary detail. Furthermore, it is expressly intended that specific elements and/or method steps described in connection with any disclosed embodiment of the invention may be incorporated into any other embodiment.

1. A filter assembly for filtering a fluid used in a laundry or textile articles washing appliance, the filter assembly comprising:
a filtering element enclosing an inlet chamber adapted to receive the fluid;
a housing adapted to house the filtering element;
an outlet chamber defined by a volume comprised between the filtering element and the housing for receiving filtered fluid resulting from passage of the fluid from the inlet chamber through a filtering surface of the filtering element;
an inlet through which the fluid is supplied to the inlet chamber;
an outlet fluidly connected to the outlet chamber, through which the filtered fluid exits the outlet chamber;
a cleaning system located inside the inlet chamber operable to remove filtered contaminants from the filtering surface, the cleaning system comprising a scraper device operable to be rotated about a rotation axis for removing filtered contaminants from the filtering surface through mechanical interaction of the scraper device with the filtering surface during rotation of the scraper device, and for moving the removed filtered contaminants away from the inlet chamber;
a collection region for collecting removed filtered contaminants moved away from the inlet chamber,
wherein:
the scraper device is configured to be movable with respect to the filtering element along the rotation axis by means of a pushing action of the collected removed filtered contaminants when an amount of filtered contaminants is collected in the collection region;
the filter assembly further comprises a position sensing system configured to sense the position of the scraper device along the rotation axis and provide a signal indicative of the sensed position.

2. The filter assembly according to claim 1, wherein the scraper device comprises an endless screw comprising a blade surrounding a central shaft, wherein the blade is configured to mechanically interact with the filter surface.

3. The filter assembly according to claim 1, wherein the rotation axis is substantially parallel to the filter surface.

4. The filter assembly according to claim 1, further comprising a plurality of guide elements coupled to the inlet chamber and extending along the rotation axis, wherein the guide elements are configured to slidingly engage with the scraper device to allow movement of the scraper device with respect to the inlet chamber along the rotation axis.

5. The filter assembly according to claim 1, wherein the pushing action of the collected removed filtered contaminants acting on the scraper device is contrasted by a biasing element associated to the scraper device.

6. The filter assembly according to claim 1, wherein the scraper device is configured to compact the removed filtered contaminants in the collection region by pressing the removed filtered contaminants in the collection region along the rotation axis in a first direction during rotation of the scraper device.

7. The filter assembly according to claim 6, wherein:
the scraper device is movable by the pushing action of the collected removed filtered contaminants along the rotation axis in a second direction opposite to the first direction.

8. The filter assembly according to claim 1, wherein the position sensing system comprises a magnetic position sensor.

9. The filter assembly according to claim 1, further comprising:
a flooding chamber fluidly connected to the outlet chamber and fluidly connectable to the inlet chamber in a selective manner by means of a fluid communication device operable for enabling a fluid communication between the inlet chamber and the flooding chamber in presence of a clogging of the inlet chamber and/or the filtering element, thereby allowing unfiltered fluid to flow towards the outlet.

10. The filter assembly according to claim 1, wherein:
the inlet chamber comprises a first inlet chamber portion fluidly connected to the inlet, and a second inlet chamber portion selectively fluidly separated from the first inlet chamber portion,
the scraper device is located in the first inlet chamber portion;
the filter assembly further comprises a fluid connection device comprising a displaceable body for selectively enabling and disabling a fluid connection between the first and second inlet chamber portions based on a working condition of the first inlet chamber portion, an enablement of the fluid connection between the first and second inlet chamber portions occurring when the working condition is indicative of a clogging of the first inlet chamber portion, thereby allowing the fluid from the inlet to flow to the second inlet chamber portion through the first inlet chamber portion, and a disablement of the fluid connection between the first and second inlet chamber portions occurring when the working condition is indicative of a non-clogging of the first inlet chamber portion to fluidly separate the first and second inlet chamber portions from each other.

11. The filter assembly according to claim 10, wherein the second inlet chamber portion receives fluid to be filtered from the inlet only when the fluid connection between the first and second inlet chamber portions is enabled.

12. The filter assembly according to claim 1, wherein the filter surface comprises a mesh having a size configured to retain particles having a minimum dimension comprised between 0.1 μm and 5 mm, preferably a minimum dimension comprised between 10 μm and 100 μm, more preferably a minimum dimension comprised between 10 μm and 75 μm.

13. A laundry or textile articles washing appliance comprising:
a control unit configured to control a laundry or textile articles treating operation of the appliance and a drain pipe to drain fluid from a laundry or textile articles treating chamber into a recirculation conduit to supply the fluid back to the laundry or textile articles treating chamber and/or a drain outside the appliance;
a filter assembly according to claim 1, wherein the inlet of the filter assembly is fluidly connected to the drain pipe and the outlet of the filter assembly is connected to the recirculation conduit and/or the drain.

14. A method for operating a filter assembly according to claim 13, comprising:
operating the scraper device of the cleaning system to be rotated about a rotation axis;
removing filtered contaminants from the filtering surface through mechanical interaction of the scraper device with the filtering surface during rotation of the scraper device;
moving the removed filtered contaminants away from the inlet chamber by means of the rotation of the scraper device;
collecting the removed filtered contaminants moved away from the inlet chamber in the collection region;
providing a signal indicative of the position of the scraper device which moves with respect to the filtering element along the rotational axis by means of a pushing action of the collected filtered contaminants when an amount of filtered contaminants is collected in the collection region.

15. The method according to claim 14, further comprising:
fluidly connecting the inlet of the filter assembly to a drain pipe of a laundry or textile articles washing appliance, wherein the drain pipe is provided to drain fluid from the laundry or textile articles treating chamber;
fluidly connecting the outlet of the filter assembly to a recirculation conduit to supply fluid back to the laundry or textile articles treating chamber and/or connecting the outlet of the filter assembly to a drain outside the appliance;
communicatively coupling the control unit of the appliance with the position sensing system of the filter assembly.

16. A filter assembly for filtering a fluid used in a laundry or textile articles washing appliance, the filter assembly comprising:
a filtering element-enclosing an inlet chamber adapted to receive the fluid;
a housing-adapted to house the filtering element;
an outlet chamber defined by a volume comprised between the filtering element and the housing for receiving filtered fluid resulting from passage of the fluid from the inlet chamber through a filtering surface of the filtering element;
an inlet through which the fluid is supplied to the inlet chamber;
an outlet fluidly connected to the outlet chamber, through which the filtered fluid exits the outlet chamber;
a cleaning system located inside the inlet chamber operable to remove filtered contaminants from the filtering surface, the cleaning system comprising a scraper device operable to be rotated about a rotation axis for removing filtered contaminants from the filtering surface through mechanical interaction of the scraper device with the filtering surface during rotation of the scraper device, and for moving the removed filtered contaminants away from the inlet chamber;
a collection region for collecting removed filtered contaminants moved away from the inlet chamber,
wherein the filter assembly further comprises a position sensing system configured to sense the position of the scraper device along the rotation axis and provide a signal indicative of the sensed position.

17. The filter assembly according to claim 16, wherein the scraper device is configured to compact the removed filtered contaminants in the collection region by pressing the removed filtered contaminants in the collection region along the rotation axis in a first direction during rotation of the scraper device.

18. The filter assembly according to claim 1, wherein the rotation axis is substantially parallel to the filter surface.

19. A filter assembly for filtering a fluid used in a laundry or textile articles washing appliance, the filter assembly comprising:
a filtering element-enclosing an inlet chamber adapted to receive the fluid;
a housing-adapted to house the filtering element;
an outlet chamber defined by a volume comprised between the filtering element and the housing for receiving filtered fluid resulting from passage of the fluid from the inlet chamber through a filtering surface of the filtering element;
an inlet through which the fluid is supplied to the inlet chamber;
an outlet fluidly connected to the outlet chamber, through which the filtered fluid exits the outlet chamber;
a cleaning system located inside the inlet chamber operable to remove filtered contaminants from the filtering surface, the cleaning system comprising a scraper device operable to be rotated about a rotation axis for removing filtered contaminants from the filtering surface through mechanical interaction of the scraper device with the filtering surface during rotation of the scraper device, and for moving the removed filtered contaminants away from the inlet chamber;
a collection region for collecting removed filtered contaminants moved away from the inlet chamber,
wherein the scraper device is configured to compact the removed filtered contaminants in the collection region by pressing the removed filtered contaminants in the collection region along the rotation axis in a first direction during rotation of the scraper device, wherein the scraper device is movable by a pushing action of the collected removed filtered contaminants along the rotation axis in a second direction opposite to the first direction, and wherein the filter assembly further comprises a position sensing system configured to sense the position of the scraper device along the rotation axis and provide a signal indicative of the sensed position.

20. The filter assembly according to claim 19, wherein the rotation axis is substantially parallel to the filter surface.
